(19) United States
(12) Patent Application Publication
(10) Pub. No.: US 2019/0246568 A1
(43) Pub. Date: Aug. 15, 2019

(54) Plant Processing System and Method to Trim Desired Plant Material

(71) Applicant: Samson Seidel, Oroville, CA (US)

(72) Inventor: Samson Seidel, Oroville, CA (US)

(21) Appl. No.: 15/894,556

(22) Filed: Feb. 12, 2018

(51) Int. Cl. A01G 3/00; B02C 17/02; B02C 17/18; B02C 21/02; B02C 25/00

(52) U.S. Cl. CPC A01G 3/00; A01G 3/002; B02C 25/00; B02C 17/1815; B02C 21/02; B02C 17/02

(57) ABSTRACT

A processing system comprising at least one cylindrical tumbler having a base portion with one or more sidewalls extending upward, where the tumbler tumbles plant material placed inside, and where the tumbled material is trimmed within the tumbler. A motor is in communication with a power source and is mechanically coupled to the base of the tumbler, so that the motor rotates the tumbler. The one or more sidewalls have a plurality of apertures configured to selectively allow one or more plant byproducts to pass through.

### CROSS-REFERENCE TO RELATED APPLICATION(S)

Not applicable

### BACKGROUND OF THE INVENTION

### 1. Field of Invention

The present invention relates to the field of processing and manufacturing of horticultural products, and more particularly to processing plant material.

### 2. Description of Related Art

Proper processing of vegetation for consumption or use is a vital part of the manufacturing process overall. Certain herbs require specific application of heat, humidity, and trimming before they are appropriate to use for their intended purpose. Once specific example of plant needing extensive processing after harvest is cannabis.

Cannabis is harvested at a predetermined time based on the length of time of growth and development of the plant. The harvested portion requires extensive curing involving drying, trimming, and processing.

While harvesting is generally done by hand, the curing and processing would follow in an extremely laborious fashion of hand trimming using trimmers or scissors. Such activity required massive amount of times and was ineffective to provide for a reproducible environment to which the plants were processed.

Specifically, trimming cannabis is a painstaking process that averages 8-12 hrs per pound to trim and at cost upwards of $200/lb to trim. The present invention is capable of reducing the cost to $50/1b and will trim up to 8 lbs every 15 minutes. At $50/1b, that is a 75% savings. This reduces the need for strangers to come into your home for days, weeks and months while you feed them, house, and endanger yourself and family by opening your home to strangers to come work. Not to mention the liability of said events! If you don't allow trimmers in your home then you have to transport your bulk of cannabis.

As technology has advanced in this area of technology, attempts have been made to automate the process. However, the capabilities are limited in their efficiency and ability to facilitate remote processing needs.

Current state of the art can be seen with U.S. patent application Ser. No. 11/456,023 by Levi Shouse entitled “Plant Trimmer” describes a trimming machine used to cut flowers or other plant material into small sized fragments or to prune unwanted thorns or leaves off of plants and flowers. This machine trims flower petals into small pieces which can be used in potpourri or other displays. This machine enables the user to generate a greater volume of flower petals then the traditional method of hand trimming with a scissors. This machine can also trim the unwanted leaves, buds or thorns off plants and flowers. However, the vertical tumbler is inefficient as gravity would force the plant material to the bottom of the container inhibiting proper curing.

Also, U.S. Pat. No. 8,127,668 to Delmar E. Snyder, Jr., entitled “Apparatus for Destemming and Vegetative Shredding” describes a vegetative shredder and destemming apparatus that includes a shredding drum having an interior volume into which a harvested plant crop may be placed for processing. The drum includes a substantially cylindrical side with a plurality of openings and at least one brush roller disposed proximate the cylindrical side. A motor rotates the shredding drum and the brush rollers simultaneously. The apparatus employs centrifugal force to urge portions of the plant material into engagement with the drum's cylindrical side and the openings therethrough so as to allow bring the brush rollers to mechanically shred and destem the plant material. However, a lack of insulative housing of the trimmer fails to provide the efficiency disclosed and described by the present invention.

These examples are also static in that they require installation into a structure or building. Such static placement requires the harvest be brought to the device. This is problematic as there are obvious issues associated with the logistics, increased times between harvest and processing, and increased loss through greater transportation distances.

Based on the foregoing, there is a need in the art a system and method for trimming and plant processing allowing for adaptable remote access, improved commercial potential, and improved efficiency.

### SUMMARY OF THE INVENTION

A processing system comprising at least one cylindrical tumbler having a base portion with one or more sidewalls extending upward, where the tumbler tumbles plant material placed inside, and where the tumbled material is trimmed within the tumbler. A motor is in communication with a power source and is mechanically coupled to the base of the tumbler, so that the motor rotates the tumbler. The one or more sidewalls have a plurality of apertures configured to selectively allow one or more plant byproducts to pass through.

The at least one cylindrical tumbler is disposed within a housing, wherein a door sealingly engages a perimeter of the one or more sidewalls.

A temperature control connects to a heater, and the controller operates a predetermined temperature within the system.

The controller is in wireless communication with a remote device, wherein the remote device communicates with the controller, wherein data is transmitted from the system to the remote device, wherein a graphical user interface displays the data on the remote device.

The housing is affixed to an interior structure of a vehicle in commercial settings.

A cutter screen is disposed to fit concentrically around at least a portion of the cylindrical tumbler drum.

The cutter screen has one or more sidewalls having a plurality of apertures, wherein the plurality of apertures of the cutter screen are a different size relative to the plurality of apertures of the at least one cylindrical tumbler.

A second tumbler disposed within the at least one cylindrical tumbler to fit in the center of the at least one cylindrical tumbler having at least a portion of a sidewall of the second tumbler comprising a wire mesh.

The second tumbler displaces at least a portion plant material placed within the at least one cylindrical tumbler toward the one or more sidewalls of the at least one cylindrical tumbler.

The one or more plant byproduct is first frozen with dry ice and then placed inside the second tumbler and rotated to remove pollen from the plant byproducts which passes through the wire mesh.

A plant stripper comprised of a rotating end mill bit fitting into a first hole in a stainless steel stripper block with at one second hole passing through the block and intercepting the first hole, whereby the rotating end mill bit masticates a plant stem when inserted into the second hole through the stripper block to strip plant material from the stem.

A plant trimming machine comprising a first cylindrical tumbler comprised of a first sidewall having a plurality of first perforations in the first sidewall sized to allow protrusion of desired plant material and a base with a keyed shaft coupled to a motor attached therein. A second cylindrical tumbler comprised of a second sidewall having at least a portion of said second sidewall made from a mesh. A cutter screen in a bent configuration to concentrically fit around at least a portion of the first cylindrical tumbler having a plurality of second perforations, wherein the second perforations exhibit a different size and angular configuration compared to the first perforations. When rotated by the shaft with said plant material inside, the first cylindrical tumbler engages protruding plant material between the first perforations and the second perforations to trim desired plant material to fall through an integral hopper system into a collector. The second cylindrical tumbler can guide, distribute, and stack plant material against first sidewall and make contact with approximately ⅔ of the available cutting surface.

A heater and fan responsive to a temperature control.

A humidity control.

A fan associated with a filter to control odor.

A wireless device in wireless communication with the trimming machine monitoring and controlling operation of said plant trimming machine.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a view of a drum screen before assembly for the plant processing system, according to an embodiment of the present invention;

FIG. 2 is a view of a cutter screen for the plant processing system, according to an embodiment of the present invention;

FIG. 3 is a perspective view of the assembled cylindrical tumbler for the plant processing system, according to an embodiment of the present invention;

FIG. 4 is a front view of the assembled cylindrical tumbler for the plant processing system, according to an embodiment of the present invention;

FIG. 5 is a front view of the assembled tumbler assembly for the plant processing system, according to an embodiment of the present invention;

FIG. 6 is a perspective side view of the pollen pail for the plant processing system, according to an embodiment of the present invention;

FIG. 7 is a front view of the pollen pail placed within the cylindrical tumbler for the plant processing system, according to an embodiment of the present invention;

FIG. 8 is a front view of the pollen pail placed within the cylindrical tumbler in operation for the plant processing system, according to an embodiment of the present invention;

FIG. 9 is a top view of the tumbler assembly of the plant processing system, according to an embodiment of the present invention;

FIG. 10 is a stylized front view of the plant processing system, according to an embodiment of the present invention;

FIG. 11 is an isolated right side view of a vehicle installation of the plant processing system, according to an embodiment of the present invention;

FIG. 12 is a side view of a vehicle installation of the plant processing system, according to an embodiment of the present invention;

FIG. 13 is a rear view of a vehicle installation of the plant processing system, according to an embodiment of the present invention;

FIG. 14 is a view of the interior of the computer bay of the plant processing system, according to an embodiment of the present invention;

FIG. 15 is a side view of a stripper rotor assembly, according to an embodiment of the present invention; and

FIG. 16 is a perspective side view of a stripper block, according to an embodiment of the present invention.

### DETAILED DESCRIPTION OF PREFERRED EMBODIMENTS

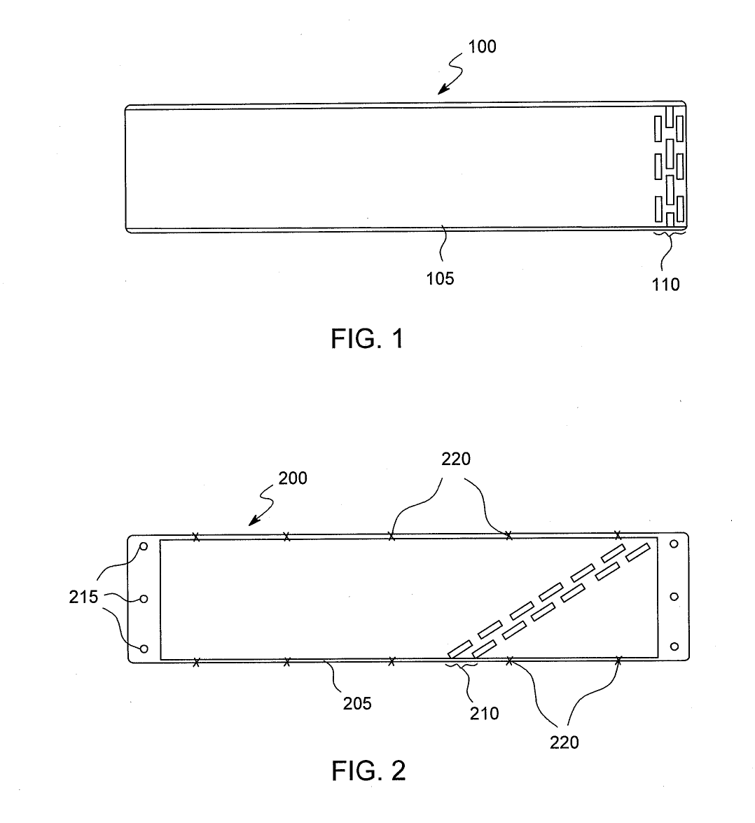

Preferred embodiments of the present invention and their advantages may be understood by referring to FIGS. 1-16.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

The computer memories in the various disclosed devices may store computer executable instructions. Each disclosed computer/communication device such as computer, a server, a system node, a smart phone, a tablet, or similar device able to execute computer code and/or process digital, electronic data may execute computer executable instructions. The computer executable instructions may be included in computer code. The computer code may be stored in the various device memories. The computer code may be written in any computer language comprising the prior art. The memory may be a non-transitory tangible storage media. Sophisticated computer apps have increasingly become available, with downloaded executable software code (e.g., the Apple® Store) providing for configuring a mobile device, such as a smart phone or tablet, to perform a plethora of functions.

The computer code may be logic encoded in one or more tangible media or one or more non-transitory tangible media for execution by the processor in the devices. Logic encoded in one or more tangible media for execution may be defined as instructions that are executable by the processor and that are provided on the computer-readable storage media, memories, or a combination thereof. Logic may include a software controlled microprocessor, an application specific integrated circuit (ASIC), an analog circuit, a digital circuit, a programmed logic device, a memory device containing instructions, and the like. The instructions may be stored on any computer readable medium comprising the prior art from which a computer, a processor, or other electronic device can read. This may include a computer data disk or the like storing computer code that can be used to configure a memory associated with a computer, a processor, or other electronic device.

The processor may include a general processor, digital signal processor, ASIC, field programmable gate array, analog circuit, digital circuit, central processing unit (CPU), micro-processor unit (MPU), micro-controller unit (MCU), combinations thereof, or other now known processor. The processor may be a single device or combinations of devices, such as associated with a network or distributed processing. The processor may be responsive to or operable to execute instructions stored as part of software, hardware, integrated circuits, firmware, micro-code or the like. The functions, acts, methods or tasks illustrated in the figures or described herein may be performed by the processor executing instructions stored in the memory.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

An herb processing system has at least one trimming device attached to a mounting means installed within a vehicle. The trimming device has at least one rotatable tumbler which rotates about a central axis within a housing. The housing may be insulated for sound remediation. The tumbler has a bottom surface with one or more sidewalls extending therefrom. At least the sidewalls have a plurality of apertures of a size configured to facilitate the trimming of a selected amount of plant material extending outward from the plant product placed therein. A motor is disposed within the housing having a shaft driven by the motor. The shaft is coaxially aligned with a center of the bottom surface of the tumbler. The shaft translates rotational energy to the tumbler.

In an embodiment, the system further comprises a user interface configured to receive selective input for the operation of the system. The interface may provide for setting temperature, rotating speed, or time or allowing for predetermined temperature, rotating speed, direction and times.

In an embodiment, the tumblers are positioned such that their axis is horizontal and they rotate about their axis.

In an embodiment, a temperature control sensor or unit control is only necessary if the cannabis has a damp core. A damp core may be determined by a moisture content evaluation means. For example, a hydrometer in the presence of damp cannabis may provide proper indication of the moisture content. A specific example exists where several pounds of cannabis are placed together in the drum is draws the core moisture out. The moisture instantly hydrates the dry leaves and causes the leaves to lay on the bud instead of poking through the cutting slots. Traditionally the cannabis needs hang time to cure properly but expressed drying can also be established from this system for early market if the client wishes.

In another embodiment, the system has a wireless transmission and wireless receiving means. Each of the wireless means operates to transmit and receive data over one or more networks. A user may provide the data through a remote device. The remote device provides for a user interface and monitoring system using an integrated computer controller.

In an embodiment, a heat source is contained within the housing. The heat source and motor are in communication with a power source configured to supply power for the selective operation of the tumbler rotation and the heating element.

In an embodiment, one or more fans may be disposed within or on the trimming device. The fans provide a forced flow of air into and/or out of the housing. In forcing air outside of the housing, the fans facilitate the removal of moisture or humidity within the housing.

In an embodiment, the housing is in communication with the mounting means. The mounting means has a first side affixed to an interior surface of the vehicle. A second side of the mounting means is attached to the housing

In an embodiment, the system may be transported to your location. Further, in an example embodiment, employees of a growing business are the users operating the system. Operation of the system is performed pursuant to the guidelines legally and naturally for cultivating the best, cleanest, largest organic medicine/recreational crop possible. In an embodiment, This system not only keeps you safe from criminal activity it also keeps you safe from pesticides, inhibits molds, bacteria, and fungus to mention just a few hazards. A very valuable service to the medicinal community. For example, anyone with a compromised immune system such as cancer patients or organ transplant simply cannot cultivate their own garden as it jeopardizes their very lives. These users may rely on others to cultivate and process their medicine, with many possible hazardous consequences.

Further, in use a method of operation may include set up a garden pre-harvest and maintain it all the way through harvest and then clean up the grow area once complete. Once the crop is complete it is then harvested and set to dry at the residence in an enclosed area with a charcoal air filter to control odors for approximately 1-2 weeks.

In an embodiment, the system promotes safety above all by highly reducing the traffic of strangers by 95% that it once took to start and finish the entire process of cultivating cannabis. Turning months into only a few hrs. In an embodiment, the entire process takes place on site as the vehicle travels to the harvest location for processing and then is able to leave after the material has been trimmed and cured.

In an embodiment, operation proceeds as the system within a vehicle comes to the clients location equipped with trimming machines and oversized charcoal filters (to eliminate the odor) that are capable of trimming the cannabis flowers to their finished state for storage. In an exemplary embodiment, each trimming machine is capable of cleaning 4-8 lbs of cannabis per load in an average of 15-20 minutes depending on the moisture content, density, flower structure, resin content, stem structure and overall quality of plant material. In an embodiment, one or more sensors and/or cameras can be disposed within the system are configured to automatically identify the moisture content, density, flower structure, resin content, stem structure and overall quality of plant material. The sensors can interface with a remote device by WiFi to remote monitor and control a trim machine. In an embodiment, the flowers are separated from the stalks and placed into the machines for service. In an embodiment, multiple machines can be used as needed to speed up the process in the event of large quantities that need to be trimmed or that there are a few different strains of plants and individual machines are needed to keep the product separate. The leaf is then trimmed from the flowers and separated.

In an embodiment, states that are medicinal only, the present system is to be registered as a Non Profit Co-Op that requires a medical recommendation and a record of service much the same as a Retail Store Front. Also for counties that do not allow for processing outside of the home. Each vehicle will be stocked with mobile trimming machines and charcoal filters to remove the odor of processing. As many machines that are needed will be used.

In an embodiment, the present system is an ideal solution for commercial operations. The present system eliminates the need for short term hiring high expenses due to the high cost of having part time employees to trim. The system can arrive on location and perform all of the commercial processing needs of commercial growers. In an embodiment, the system will have two people and machines that will replace dozens of workers in a fraction of the time on a pay by the pound basis or flat rate canopy processing by the sq ft.

In an embodiment, the system may provide for rentals to clients that want to remain anonymous and have no one coming to their home. These trimming devices will be rented out with credit card deposit/Cash deposit of 50% of the retail value. These machines are equipped with non-tamper GPS and cellular tracking unit. In an embodiment, machines are charged by the minute, day, week or month.

In an embodiment, a pollen extraction means is in communication with the system. The pollen extraction means collects and/or removes pollen from a pollen-producing object placed within the system. Such extraction means significantly increases the efficiency of the system. It also safely extract the pollen from the leaves with no chemicals leaving it organic and safe.

In an embodiment, a cutter blade is disposed within or substantially near a perimeter of one or more of the tumblers. The cutter blade is configured to sever terminal portions of organic material extending outward from the apertures. For example, where cannabis has a pointed terminal end of leaves extending from a bud of the plant, the terminal ends will be tumbled within the tumbler, extend out from the apertures, and be removed by the cutter. In such an embodiment, where there are multiple tumblers, the outer tumblers may provide for the cutting means of the terminal ends. In another embodiment, safety springs on the cutter blade greatly extend the life of the blade. In an embodiment, the springs allow it to fit snug but allow it to be secure without being hard mounted and remain flexible.

In an embodiment, the components of the system are not coated with any plating or additional substance such as Teflon. Such coating may be transferred to the processed product over time. The cutting components may be made from stainless steel or titanium or some other steel alloy in an embodiment.

In an alternative embodiment, a stripper mechanism is provided in conjunction with the system. The stripper provides for a grinding or precision cutting mechanism configured to reduce or remove stems from the organic material prior to being placed within the system. The stripper may provide for an opening whereby a stein is positioned within the opening a series of blades and grinding material may be moving on the other side of the opening and when the stem makes contact, the blades remove stem material until the stem is removed from the opening.

In another embodiment, a filtration system may be provided wherein a fan is positioned within ducting between the interior of the system and a filter. The filter may be HEPA or multi layered having activated charcoal Or other components sufficient to reduce the dispersion of fine particulate and odor.

In an embodiment, supplemental systems operating within the system described herein may include at least “Pollen Pail”, which significantly increases the efficiency of the cutter system overall. The increased efficiency is defined by utilization or otherwise lost byproducts, such as the pollen becoming dislodged from the plants within the system. Pollen pail is an extraction and collection mechanism in communication with the machine configured to retrieve lost pollen from the trimming process. An example of the pollen pail would provide for a surface positioned significantly near the tumblers such that as pollen is released from the Plant, it will fall out and migrate into the tumbler and fall down past a hopper system into a collection box. In this way, pollen is safely extracted from the leaves with no chemicals leaving it organic and safe.

In an embodiment, two or more safety springs on the cutter blade greatly extend the life of the blade. Hard large stems can destroy the cutting drum. The springs allow it to fit snug but allow it to be secure without being hard mounted. The springs may provide for a biasing force to selectively control operation of the cutting blades in relation to the tumblers. The cutting blades may be deployed during use, where the blades are positioned effectively close to the tumbler so that extruding plant material is trimmed off, allowing for their cutting of the herb parts extending outward from the tumblers.

In an embodiment, one or more safety precautionary mechanisms are disposed within the system. For example, one or more sensors may sense the inappropriate position of a user's hands near the cutting or articulating parts of the system. The sensor may then trigger an emergency stop or an alarm signal to prevent injury.

One or more HEPA filters and/or bags are positioned at various locations throughout the system to provide for air purification. For example, exhaust outlets may expel air within the system during operation for cooling or circulation purposes. Within the path of the expelled air, the filters act to prevent the distribution of smells or particulate. A specific example provide for a filtration system at or near the pollen pail to prevent the distribution of pollen into surround ambient air.

These machine of the invention can exhibit various sizes and features. The metal components are made out of quality materials primarily aluminum and stainless steel with natural wood veneers for beautiful showroom quality in any setting primarily for non-commercial applications. We also feature a more industrial outer shell made of plywood and plastic panels for a quality industrial look to use in commercial applications. Various sizes and styles can be used or custom-made options can be provided to a user's specifications.

FIGS. 1-16 show components of the tumbler cutting system in an embodiment. FIG. 1 depicts a drum screen in an unassembled state 100 and can comprise a stainless steel sheet 105 approximately 60″ long, 18″ wide, and 0.065″ (16 gauge) thick. The stainless steel sheet 105 further can comprise an array of rectangular perforations 110 approximately 3/16″×1¾″×¼″ in size in the sheet arranged in a 90° angle relative to the stainless steel sheet 105. In an assembled state, the stainless steel sheet 105 can be rolled and welded into a tube configuration to form a cylindrical tumbler or drum screen.

FIG. 1 depicts a cutter screen 200 in an unassembled state and can comprise a stainless steel sheet 205 approximately 60″ long, 18″ wide, and 0.065″ thick, which can be referred to as a cutter blade. The stainless steel sheet 205 further can comprise an array of rectangular cutting perforations 210 approximately 2″×¾″ in size and ¼″ apart in the sheet arranged in a 31.5° angle relative to the edge of stainless steel sheet 205. At the ends of stainless steel sheet 205 a set of three holes 215 5/16″ in diameter in a 2″ wide area of the stainless steel sheet 205 can be provided. The side of cutter screen 200 can include several sealed roller bearings 220 to greatly reduce the surface to surface friction between the cutter drum 300 and the cutter screen 205. With the addition of the compression springs 820 to minimize possible damage to both cutter drum 300 and screen 205.

Roller bearings 220 placed along the longitudinal edges and can be placed at the 8″, 15″, 22.5″, 30″, and 37″ positions along the length of the cutter screen 200. In an assembled state, the stainless steel sheet can be bent into a “U” or semi-circular shape to at least partially surround a tumbler to form a cutter screen or blade.

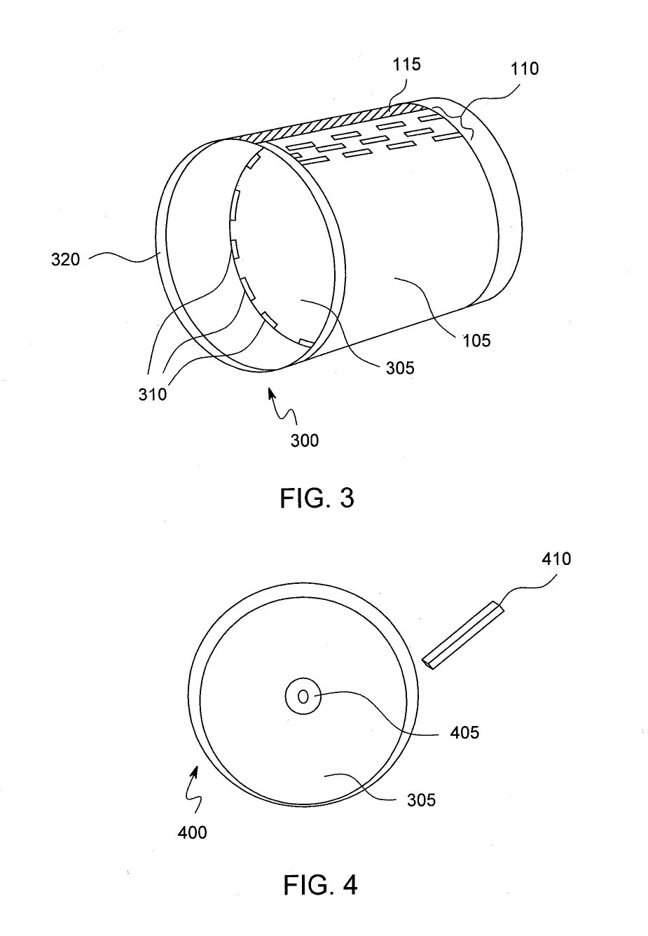

FIG. 3 shows an embodiment of the cylindrical tumbler drum 300 in a ¾ view. Tumbler drum 300 can comprise a stainless steel sheet 105 bent into a cylindrical tumbler drum and secured with welded seam 315. Cylindrical tumbler drum 300 further can comprise rectangular perforations 110 in the sheet 105 with a stainless steel plate 305 attached to form the base of the cylindrical tumbler drum 300 and secured by elongated spot welds 310 spaced approximately 1″ long and 3″ apart. A stainless steel or black steel ring 320 approximately ½″ wide×¼″ thick can likewise be welded to the inside edge of the cylinder to form an upper inside or outer edge of the cylindrical tumbler drum 300. The stainless steel or black steel ring 320 needs to be recessed at least ¼″ to accommodate fitting and operation of a door.

FIG. 4 depicts the cylindrical tumbler drum 300 in a front view. Stainless steel plate 305 can comprise stainless steel about 19.5″ wide and 3/16″ thick. In the center of plate 305, a hub 405 can placed and comprises a 3″ wide and 1″ thick steel ring welded in place on the interior having a 1″ open center. The hub 405 can include a key configuration at the center that fits onto a 6″ keyed shaft 410. Pollen pail mounting ring 415 can comprise a 1″×¼″ ring of carbon or stainless steel welded to the plate using 1″ welds every 6″ on the outer edge of ring 415, which provides alignment and support for a pollen pail (see below). The interior of the pollen pail mounting ring 415 can be 34.5″ in diameter.

To construct the tumbler drum 300, the drum screen 105 can be rolled into a cylinder and welded forming a sidewall. The plate 305 can be welded to form a tumbler bottom. Plate 305 can include a hub 405 comprising a steel ring welded in the center of plate 305 flush with the inside of the tumbler drum 300. The upper edge of tumbler drum 300 can comprise a ½″ wide×¼″ thick steel ring welded to the upper/top edge of tumbler drum 300. This ring can be formed from ¼″×½″ flat stock and welded approximately ¼″ below the upper/top inside edge of tumbler drum 300. All welds can be performed on the interior of the tumbler drum 300 and can accommodate a door system and removal for periodic cleaning. The door system can be magnetically mounted for safety and recess for cleaning and emptying.

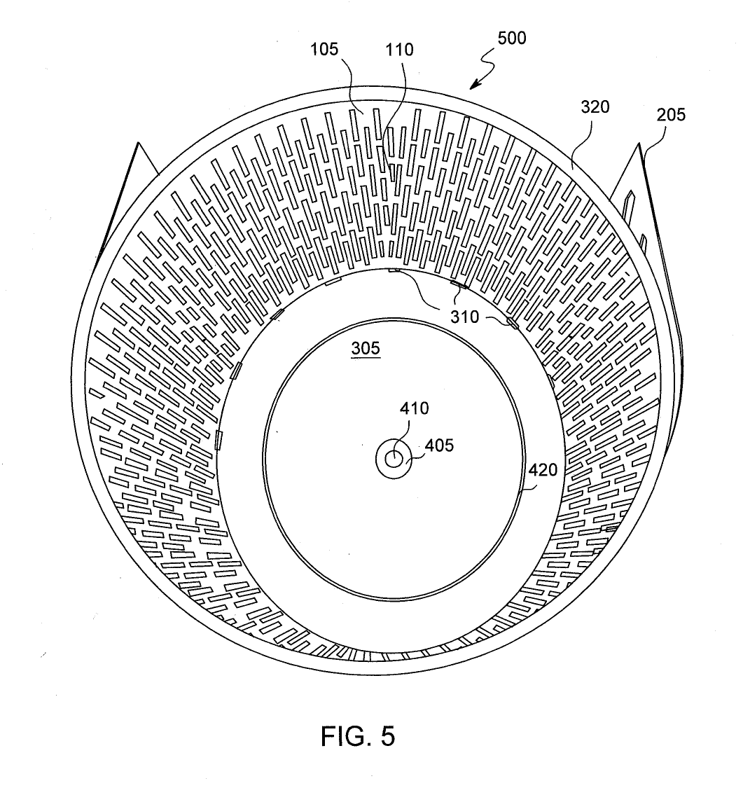

FIG. 5 depicts the tumbler system 500 showing the relative configuration of tumbler drum 300 with cutter screen 205. Drum screen 105 as depicted has been rolled into a cylinder and welded together and can comprise perforations 110 to allow protrusion of plant material in operation and steel ring 320 forming an upper inside or outer edge. The inner end of tumbler drum 300 can comprise steel plate 305, which can be attached to drum screen 105 by welds 310, and further can comprise a steel ring 405 at the center accommodating a keyed shaft 410, which rotates tumbler drum 300 during operation. The cutter screen 205 can be rolled and configured as a “U” shaped or semi-circular cutter blade to cut plant material protruding through perforations 110 when rotated and fits concentrically around at least a portion of cylindrical tumbler drum 300, or the cutter blade can substantially surround the tumbler drum 300.

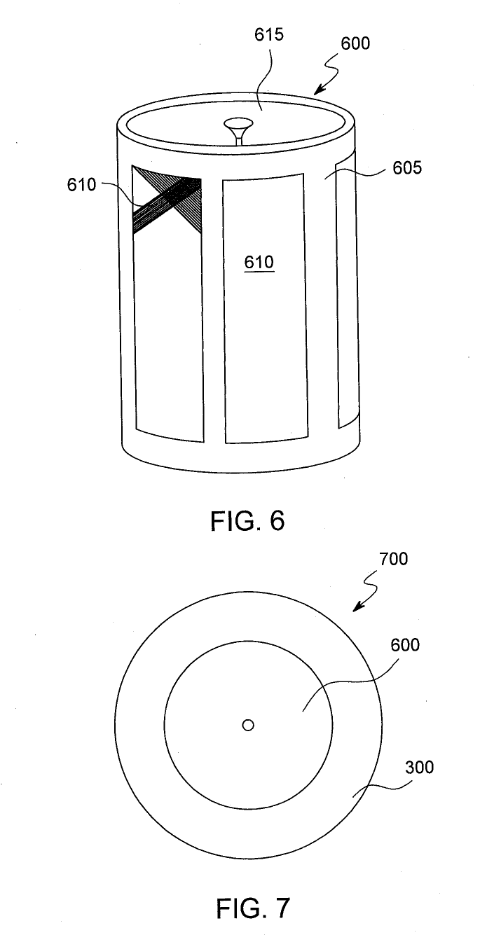

FIG. 6 depicts a multi-use pollen pail 600 to place inside the tumbler drum 300. The pollen pail 600 can comprise a framed body 605 with a plurality of wire mesh panels 610 on the sides. The pollen pail 600 can be approximately 12″ in diameter and 15″ high. The mesh panels 610 are approximately 5″×13″ in size with a rectangular framing of 1″ around the periphery. The panel 610 further comprises a 150 micron stainless steel mesh through which pollen can pass. A magnetic lid 615 can be used to close over and seal the interior of pollen pail 600.

FIG. 7 depicts the assembled components of the tumbler-pail system 700. The tumbler-pail system 700 can include tumbler drum 300 with pollen pail 600 suspended inside the tumbler drum 300 by at least four 20 pound magnets and fitted inside pollen pail mounting ring 415. The pollen pail 600 can be suspended and centered in tumbler drum 300 using a system of four 20 pound magnets. A magnetic lid 615 can be held in place by magnets or the magnets replaced by a mechanical latch mechanism to close and seal pollen pail 600. Pollen pail mounting system can consist of a ¼″×1″ standard carbon steel ring centered on tumbler drum 300. Welds used to form the pail 600 can be positioned on the exterior of the pail 600. Magnets can be mounted on the bottom of the outside base of the pollen pail.

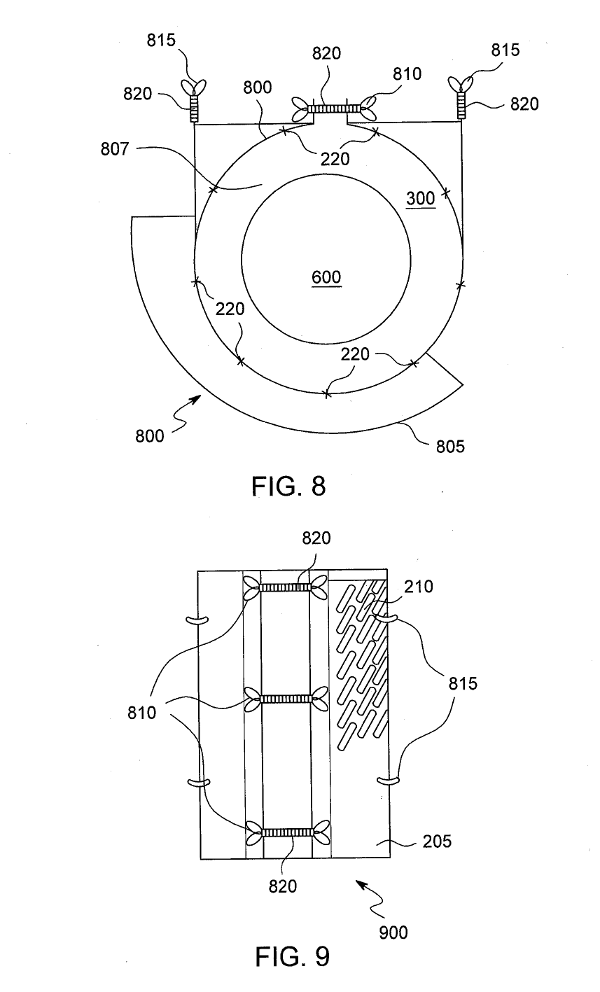

FIG. 8 depicts front view of an operational configuration 800 of the Pollen-pail system 700. Pollen-pail system 700 can comprise a cutting area 805 wherein plant material is guided and confined to protrude from tumbler drum 300 and engage with cutting perforations 210 of cutter screen 200 (over arc 805 representing about ⅔ of the available cutting surface). Pollen pail 600 can mount in the center of tumbler drum 300 to keep plant material 807 displaced toward the periphery of the tumbler drum 300, so that the plant material 807 engages a greater portion of the cutter screen 200. Horizontal J-bolt 810 in conjunction with safety spring 820 and vertical J-bolt 815 can provide a biasing force to selectively control the fit onto the cutting blades formed by the cutting perforations 210 in relation to the tumbler drum 300. Vertical J-bolts 815 and safety springs 820 secure vertical supports for the cutter screen 200 against tumbler drum 300. Tumbler drum 300 can rest against sealed roller bearings 220 to smoothly and easily rotate against cutter screen 200.

As configured, the plant material 807 can be distributed to stack up in the tumbler drum 300 to make contact to a larger proportion of cutter screen 200. As the plant material 807 tumbles around inside the tumbler drum 300, parts of the plant protrude through rectangular perforations 110 to engage with cutting perforations 210; engaging approximately ⅔ of the available cutting surface. As the tumbler drum 300 rotates, the plant material constantly fills in top portion of the tumbler drum 300.

The pollen pail 600 can be used for three main functions. First, it displaces and distributes plant material peripherally toward the entire available cutting surface resulting in faster trim times and a closer cut. (Example—Car tire only uses around 10% of its working surface when it touches the ground. The Pollen-pail 600 allows for the 60% void of cutter surface caused by gravity to be reclaimed. Second, trimmed plant material can be frozen with dry ice and loaded into the pollen pail. Freezing the trimmed plant material with dry ice makes the pollen fall off very easily. This clean and safe extraction method is 100% toxin free and more importantly it replaced the insanely dangerous and expensive method of butane extraction. As the pollen pail 600 rotates, the enclosed frozen plant material tumbles about the interior and pollen shakes out of the pollen pail to the collection drawer (not shown) of the machine. Third, the flowers being trimmed 805 are gently forced into a greater proportion of the cutting surface to trim cleaner and faster. Furthermore, the trim machine can include a setting to make the tumbler drum 300 rotate and shake for an even closer trim.

FIG. 9 shows a top view of an operational configuration 900 of the tumbler-pail system 700. The cutter screen 205 with cutting perforations 210 can be rolled into an almost circular configuration with horizontal J-bolts 810 and safety springs 820 linking and securing the ends of cutter screen 205 in place. Vertical J-bolts 815 and safety springs (not shown) suspend the cutter screen 205 around the tumbler drum 300.

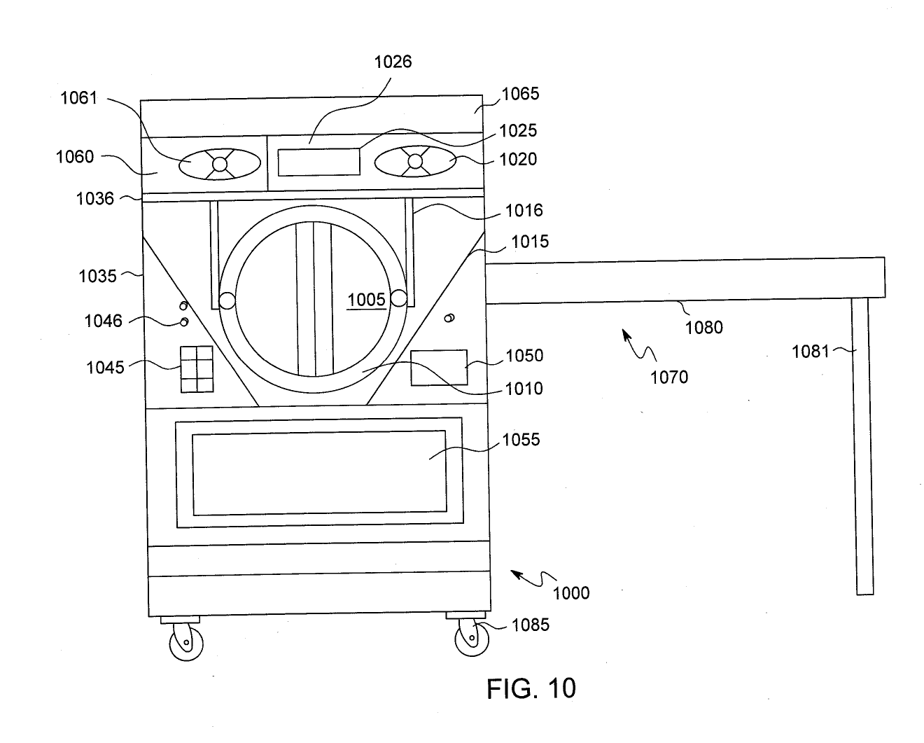

FIG. 10 depicts a stylized view of a trim machine 1000 according to an embodiment. Tumbler drum door 1005 can be secured closed by a magnet or mechanical latch mechanism engaging the perimeter edge of the wall of cylindrical tumbler drum assembly 1010. Cylindrical tumbler drum assembly 1010 can be positioned within a hopper system 1015 positioned and configured to direct trimmed pant material into a collection box 1055. A cutter slide out guard 1016 can be used along with hopper 1015 to isolate the cylindrical tumbler drum 1010 and help direct untrimmed material into the tumbler drum 1010. Fan 1020 can provide a forced flow of air into and/or out of the housing and can be in communication with a heater and used to facilitate the removal of moisture or humidity within the machine housing. The fan 1020 may also create an amount of negative pressure to facilitate the curing and removal or trimmed particulate from the plant. The fan 1020 can further be associated with an air filtration system to control odor and particulate emissions.

A docking port for WiFi tablet 1025 can be provided in wireless communication with trim machine 1000 to control and monitor trim machine 1000 by interfacing with various control inputs to support rotation speed of the tumbler drum 1010, monitor humidity, temperature, and a timer for operating the trim machine 1000. WiFi tablet 1025 (or other wireless device) can provide a graphical user interface to display data transmitted from the system of the trim machine 1000 and transmit control inputs to trim machine 1000. A pin hole camera 1026 can be provided with a wide angle field of view to monitor for security and can be associated with a 50K megabyte USB storage and a battery. Lights 1030 can be positioned inside and under the machine to provide indirect lighting for aesthetic purposes. Light control 1035 can operate an internal light to the trim machine 1000 to illuminate the interior of tumbler drum 1010. Heater control 1040 can control an internal heater to set the interior temperature of operating trim machine 1000 and collection box 1055 to regulate the drying and curing process. Speed control 1045 can control the speed of rotation of tumbler drum 1010. Humidity control 1050 can be used to help regulate heater control 1040 as well as fan 1020, heater, and/or a humidifier to further control humidity and curing of the plant product.

Collection box 1055 can be configured and positioned in association with hopper 1015 to receive trimmed plant material. Further, collection box 1055 can comprise a 150 or 190 micron screen selected and installed by a user. Other sized screens can be included as well.

A computer bay 1060 can be provided housing a computer controller. Computer bay 1060 can include fan 1061 to cool the computer bay.

The top of trim machine 1000 can comprise a sorting table 1065 with a stripper and loader/storage for storing stripped plant material before putting into tumbler 1010. An integral case lid 1080 of trim machine 1000 can be used as a table and can include a folding table leg 1081. Locking casters 1085 at the bottom of trim machine 1000 can facilitate easy roller movement.

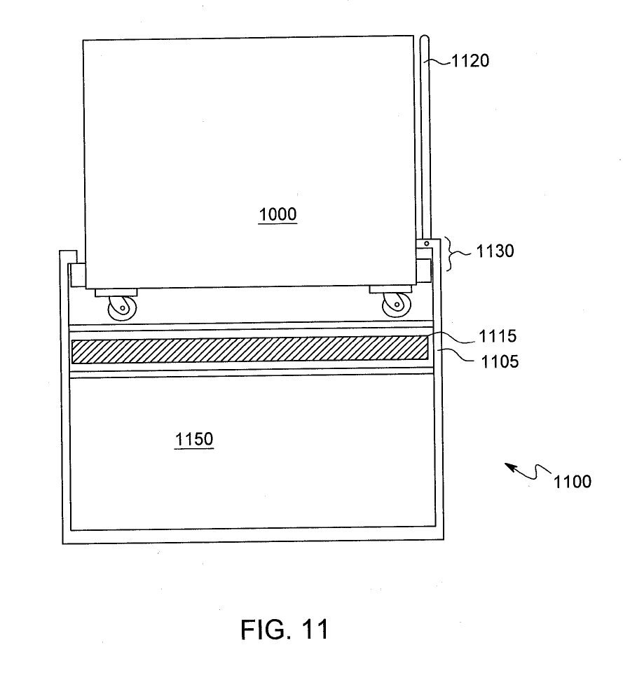

FIG. 11 depicts a rear view of a vehicle installation configuration 1100 for trim machines 1000. Support cabinet 1105 can accommodate at least one trimmer machine 1000 in an elevated position inside a vehicle. Support cabinet 1105 can be constructed over wheel well 1110 and houses a ramp 1115 that can be extended out of the vehicle so that a trim machine 1000 can be wheeled up the ramp 1115 and onto support cabinet 1105. The support cabinet 1105 can include a swing down latch 1120 that can be used to secure trim machine 1000 in place by swinging down and locking in place. The support cabinet 1105 and trim machine 1000 can form a rail retention 1130 running the length of the vehicle. A lower frame 1150 can be located in the lower portion of support cabinet 1100. In an embodiment, the support cabinet can extend upward approximately 14″ to 22″ high and the trim machine approximately 30″ high.

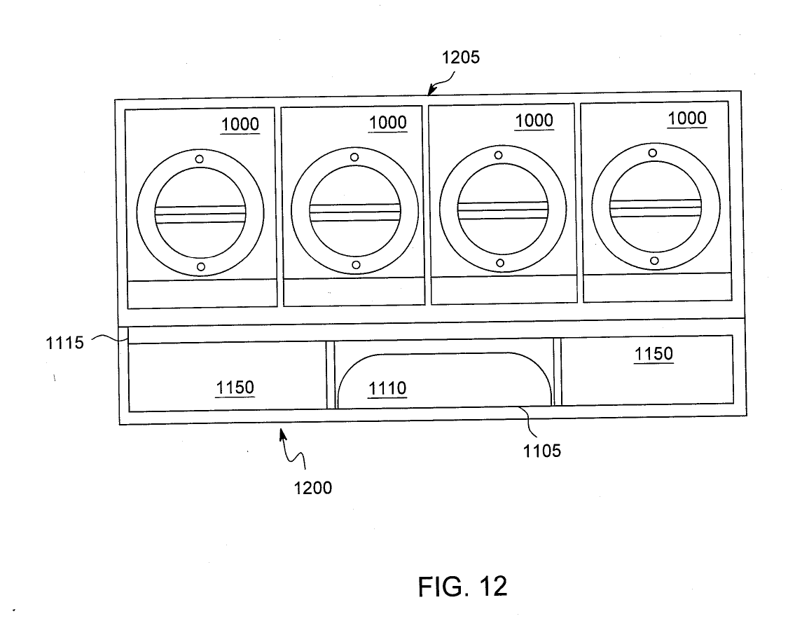

FIG. 12 depicts a side view of a trimmer machine 1000 vehicle installation 1200. Support cabinet 1105 can extend down the length of the vehicle about 94″ overall length. Multiple trim machines 1000 can be accommodated down the length of the vehicle and support cabinet 1105. In an embodiment, four trim machines 1000 can each have a width of about 23″. Lower frame 1150 can accommodate and incorporate a storage drawer. Ramp 1115 can be stored along the length of storage cabinet 1105.

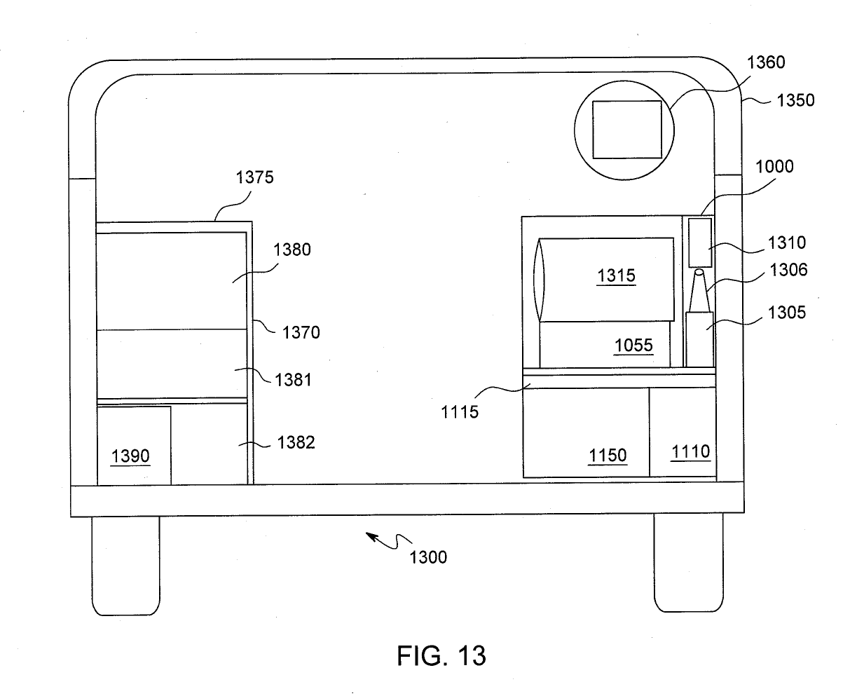

FIG. 13 depicts a full rear view of a vehicle installation 1300 across the width of the vehicle. Trim machine 1000 as shown can be carried on the right side of a vehicle as done in FIG. 11. Support cabinet 1150 can be used for storage and provides adequate vertical space to accommodate wheel well 1110. As shown, trim machine 1000 can include drawer 1055 to receive trimmed plant material. An electric motor 1305 can power a transfer shaft or drive chain 1306 that rotates tumbler 1315 at a shaft attached to the base of tumbler 1315. A heater 1310 can provide heat to plant product inside tumbler 1315 and drawer 1055. A box fan with a charcoal filter 1360 can be located above trim machine 1000 and attached to vehicle body 1350 to process interior air to remove and control odor from the plant material. The box fan and charcoal filter 1360 can be in communication with fan 1020 by ducting to augment airflow into trim machine 1000 and/or process exhaust air. Ramp 1115 stored in support cabinet 1150 allows for easy rolling of trim machine in and out of vehicle.

As depicted, left side of a vehicle can include a storage bin 1370 that can extend at least a portion of the length of the vehicle. The storage bin 1370 can comprise a work table 1375 on the upper surface of storage bin 1370. Storage bin 1370 can include an upper storage compartment 1380 that can be used to store totes and/or resale items. A medium storage compartment 1381 can store garden supplies, and a lower storage compartment 1382 can be used for miscellaneous storage. Generator 1390 can provide an independent power supply to power trim machine 1000 and the other electrical components in the vehicle.

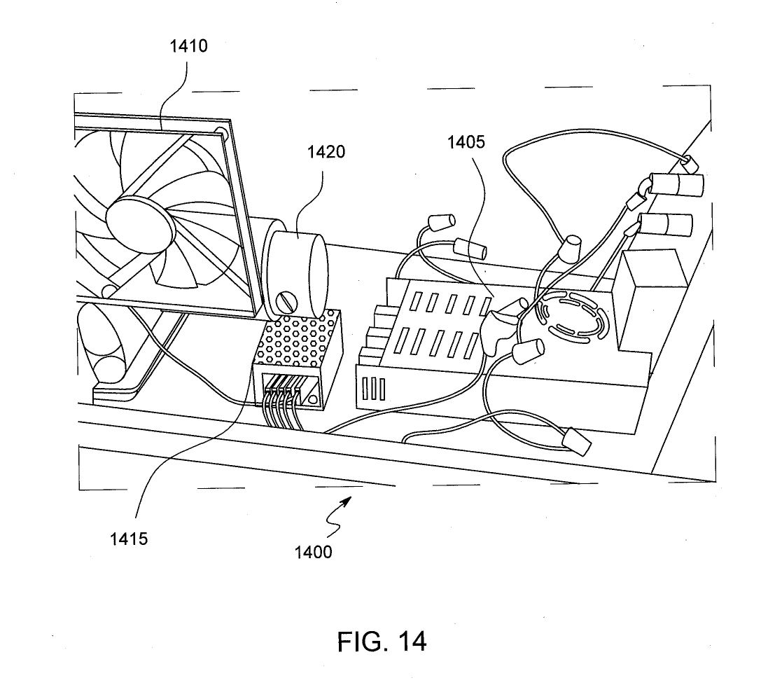

FIG. 14 depicts a computer bay interior 1400. A computer controller 1405 can be included inside computer bay interior 1400. Cooling fan 1410 can provide cooling air inside the computer bay interior 1400. Computer interface 1415 can provide control and/or monitoring for computer controller 1405. Computer bay interior can also include a motor 1420 to rotate the tumbler 1315. The computer controller 1405 can facilitate communication over a WiFi or Internet interface with a wireless device or laptop computer for control and monitoring.

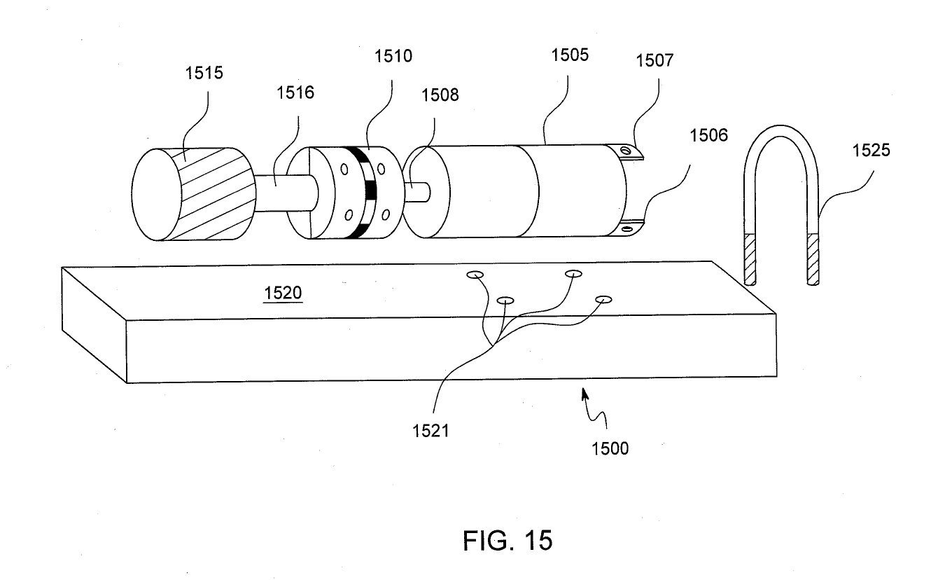

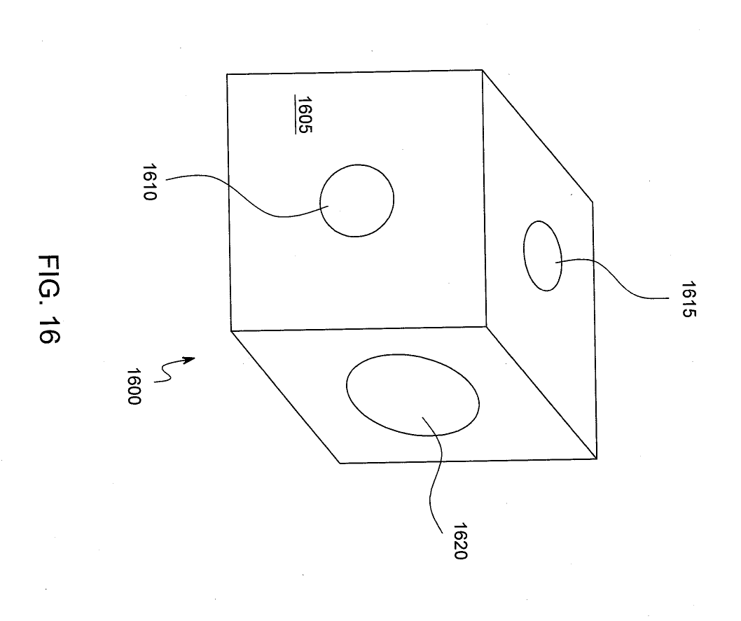

FIG. 15 is a side view of a stripper rotor assembly in an embodiment. The flower stripper assembly 1500 comprises an electric motor 1505. Electric motor 1505 can comprise a 500 rpm or higher rotation speed generating high torque and using 12 volt power. Electric motor 1505 can include power terminals 1506 and 1507 to receive power from an external power supply. The shaft 1508 rotates when power is applied. Shaft 1508 connects to spider coupler 1510, which connects motor shaft 1508 to an end mill bit shaft 1516 of end mill bit 1515. Spider coupling can be about ¼″×¼″. Mill bit shaft 1516 can also be about ¼″ in diameter. End mill bit 1515 can be about ¾″ in diameter. The motor 1505 can be secured to steel block 1520 by two U fasteners 1525 inserted into and secured to steel block 150 by fastener holes 1521.

FIG. 16 is a perspective side view of a stripper block 1600 according to an embodiment. The stripper block comprises a stainless steel cube 1605 about 1¼″×1¼″. Steel cube 1605 comprises of two centered ¼″ holes 1610 and 1615 milled through the steel block 1605 on adjacent sides and a centered about ¾″ hole 1620 milled through the steel block 1605 at a 90° to the ¼″ holes 1610 and 1615. In an embodiment, in use the ¼″ end mill bit 1515 of the stripper assembly 1500 can go into the stripper block 1600 ¼″ hole 1620 and is turned on to rotate at 500 rpm. The stripper block 1600 can be secured to steel block 1520, so that when plant stems are inserted into hole 1610, the stems are fed into holes 1610 and waste product exits through holes 1610 and 1615 (underside of 1600 not shown). The stalks/stems are fed in and all plant materials are stripped off during the mastication of the stalks/stems. The stalks/stems will be pushed through leaving flowering parts and stripped leaves behind at holes 1610 and 1615.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A processing system comprises:
a. at least one cylindrical tumbler having a base portion with one or more sidewalls extending upward therefrom, wherein the tumbler tumbles plant material placed therein, wherein the tumbled plant material is trimmed within the tumbler; and
b. a motor in communication with a power source, wherein the motor is mechanically coupled to the base of the tumbler, wherein the motor rotates the tumbler;
wherein the one or more sidewalls have a plurality of apertures configured to selectively allow one or more plant byproducts to pass through for trimming.

2. The system of claim 1, wherein the at least one cylindrical tumbler is disposed within a housing, wherein a door sealingly engages a perimeter of the one or more sidewalls.

3. The system of claim 1, further comprising a temperature control connected to a heater, wherein the controller operates a predetermined temperature within the system.

4. The system of claim 3, wherein the controller is in wireless communication with a remote device, wherein the remote device communicates with the controller, wherein data is transmitted from the system to the remote device, wherein a graphical user interface displays the data on the remote device.

5. The system of claim 1, wherein the housing is affixed to an interior structure of a vehicle.

6. The system of claim 1, further comprising a cutter screen disposed to fit concentrically around at least a portion of the cylindrical tumbler drum.

7. The system of claim 6, wherein the cutter screen has one or more sidewalls having a plurality of apertures, wherein the plurality of apertures of the cutter screen are a different size relative to the plurality of apertures of the at least one cylindrical tumbler.

8. The system of claim 1, comprising a second tumbler disposed within the at least one cylindrical tumbler to fit in the center of the at least one cylindrical tumbler having at least a portion of a sidewall of the second tumbler comprising a wire mesh.

9. The system of claim 8, wherein the second tumbler displaces at least a portion material placed within the at least one cylindrical tumbler toward the one or more sidewalls of the at least one cylindrical tumbler.

10. The system of claim 8, wherein the one or more plant byproduct is first frozen with dry ice and then placed inside the second tumbler and rotated to remove pollen from the plant byproducts which passes through the wire mesh.

11. The system of claim 1, further comprising a plant stripper, said stripper comprising a rotating end mill bit fitting into a first hole in a stainless steel stripper block with the second hole passing through the block and intercepting the first hole, whereby the rotating end mill bit masticates a plant stem when inserted into the second hole through the stripper block to strip plant material from the stem.

12. A plant trimming machine, comprising:
a first cylindrical tumbler comprised of a first sidewall having a plurality of first perforations in the first sidewall sized to allow protrusion of desired plant material and a base with a keyed shaft coupled to a motor attached therein;
a second cylindrical tumbler comprised of a second sidewall having at least a portion of said second sidewall made from a mesh;
a cutter screen in a bent configuration to concentrically fit around at least a portion of the first cylindrical tumbler having a plurality of second perforations, wherein the second perforations exhibit a different size and angular configuration compared to the first perforations;
wherein when rotated by the shaft with said plant material inside, the first cylindrical tumbler engages protruding plant material between the first perforations and the second perforations to trim desired plant material to fall through an integral hopper system into a collector; and
wherein the second cylindrical tumbler can guide, distribute, and stack plant material against the first sidewall and make contact with a cutting surface of the cutter screen.

13. The plant trimming machine of claim 12, further comprising a heater and fan responsive to a temperature control.

14. The plant trimming machine of claim 13, further comprising a humidity control.

15. The plant trimming machine of claim 12, further comprising a fan associated with a filter to control odor.

16. The plant trimming machine of claim 12, further comprising a wireless device in wireless communication with the trimming machine monitoring and controlling operation of said plant trimming machine.

17. The plant trimming machine of claim 12, further comprising a plant stripper, said stripper comprising a rotating end mill bit fitting into a first hole in a stainless steel stripper block with a second hole passing through the block and intercepting the first hole, whereby the rotating end mill bit pulls a plant stem when inserted into the second hole through the stripper block to strip plant material from the stalk/stem.
